(19) United States
(12) Patent Application Publication
(10) Pub. No.: US 2008/0229590 A1
(43) Pub. Date: Sep. 25, 2008

(54) ROOFMATES SHINGLE KNIFE

(76) Inventor: Robert Garrett, Severn, MD (US)

Correspondence Address: ROBERT PLATT BELL;REGISTERED PATENT ATTORNEY, P.O. BOX 13165, Jekyll Island, GA, 31527, US

(21) Appl. No.: 12/041,260

(22) Filed: Mar. 3, 2008

Related U.S. Application Data
(63) Continuation-in-part of application No. 10/691,967, filed on Oct. 24, 2003, now abandoned.
Application No. 10/691,967 is a continuation-in-part of application No. 10/388,642, filed on Mar. 17, 2003, now Pat. No. 6,926,241.
Application No. 10/388,642 is a continuation-in-part of application No. 10/050,964, filed on Jan. 22, 2002, now Pat. No. 6,745,869.
Application No. 10/050,964 is a continuation-in-part of application No. 11/175,958, filed on Jul. 6, 2005.
(60) Provisional application No. 60/892,644, filed on Mar. 2, 2007.
(60) Provisional application No. 60/992,981, filed on Dec. 6, 2007.
(60) Provisional application No. 60/365,538, filed on Mar. 20, 2002.
(60) Provisional application No. 60/426,808, filed on Nov. 18, 2002.
(60) Provisional application No. 60/262,650, filed on Jan. 22, 2001.
(60) Provisional application No. 60/286,527, filed on Apr. 27, 2001.
(60) Provisional application No. 60/297,530, filed on Jun. 13, 2001.
(60) Provisional application No. 60/304,098, filed on Jul. 11, 2001.
(60) Provisional application No. 60/586,227, filed on Jul. 9, 2004.

(51) Int. Cl. B27B 19/02; B27B 19/04

(52) U.S. Cl. 30/394; 30/277.4

(57) ABSTRACT

In one embodiment of the present invention, SHINGLE KNIFE™, comprises a pneumatically powered miniaturized reciprocating or circular saw designed especially for roofing applications. In an alternative embodiment, SHINGLE KNIFE™ may be powered by rechargeable battery packs or the like. SHINGLE KNIFE™ is roughly size and shape of a Prior Art razor knife, but may be powered and provided with a depth gauge to prevent cutting through roofing underlayment or the like. In another embodiment of the present invention, the SHINGLE KNIFE™ may be provided for cutting sheetrock. A reciprocating, sharpened hook shaped blade pulls though the sheetrock, making a clean cut with little or no powdery debris. The SHINGLE KNIFE for sheetrock may be air or battery powered.

### CROSS-REFERENCE TO RELATED APPLICATIONS

The present application claims priority from Provisional U.S. Patent Application Ser. No. 60/892,644, filed on Mar. 2, 2007 and incorporated herein by reference; The present application claims priority from Provisional U.S. Patent Application Ser. No. 60/992,981, filed on Jan. 19, 2008, and incorporated herein by reference; The present application is a Continuation-In-Part of U.S. patent application Ser. No. 10/691,967, filed on Oct. 24, 2003, incorporated herein by reference, which in turn is a Continuation-In-Part of U.S. patent application Ser. No. 10/388,642, filed on Mar. 17, 2003, Now U.S. Pat. No. 6,926,241, incorporated herein by reference, which in turn claims priority from Provisional U.S. Patent Application No. 60/365,538, filed on Mar. 20, 2002, and incorporated herein by reference; application Ser. No. 10/388,642, filed Mar. 17, 2003 also claims priority from Provisional U.S. Patent Application No. 60/426,808, filed on Nov. 18, 2002, incorporated herein by reference; application Ser. No. 10/388,642, filed Mar. 17, 2003 is also a Continuation-In-Part of U.S. patent application Ser. No. 10/050,964, filed on Jan. 22, 2002, now U.S. Pat. No. 6,745,869, incorporated herein by reference; which in turn claims priority from the following Provisional Patent Applications, all of which are incorporated herein by reference: Provisional U.S. Patent Application No. 60/262,650, filed on Jan. 22, 2001; Provisional U.S. Patent Application No. 60/286,527, filed on Apr. 27, 2001; Provisional U.S. Patent Application No. 60/297,530, filed on Jun. 13, 2001; and Provisional U.S. Patent Application No. 60/304,098, filed on Jul. 11, 2001; The present application is also a Continuation-In-Part of U.S. patent application Ser. No. 11/175,958, filed Jul. 6, 2005, and incorporated herein by reference, which in turn claims priority from Provisional U.S. Patent Application No. 60/586,227 filed on Jul. 9, 2004, and incorporated herein by reference.

### FIELD OF THE INVENTION

The present invention relates to the field of residential and commercial roofing. In particular, the present invention relates to an air or battery powered knife for use in cutting roofing shingles, cement board, sheetrock, and other construction materials.

### BACKGROUND OF THE INVENTION

When installing roofing materials, it is often necessary to cut shingles either before installation, or in situ. For example, when building a roof “Valley”, shingles may be installed over the valley, and then later cut to the valley “V” shape. In addition, when finishing a roof, it is often necessary to cut the shingles along the edge of the roof to provide a uniform appearing edge. These shingles may be 3 or more layers thick in some places, dulling traditional knives and saws quickly.

Traditionally, a knife has been used for such cuts. However, there is little precision in depth of cut with a knife, and in addition, such a cut can be laborious and difficult. Too deep a cut may create roof leaks. Power saws and the like are difficult to use as the saw may require an extension cord on the roof and also the blade may not be well suited for cutting shingles (i.e., it will “load up” with tar and other materials and cease to cut well). In addition, large power tools present a hazard to workers below if they fall off the roof. What is needed is a small powered tool, which can cut shingles accurately and cleanly.

Cutting sheetrock has always been problematic. Cutting large pieces has always been a matter of scoring a sheet with a sheetrock knife, X-ACTO™ knife or the like, and then breaking the sheet. However, for cutouts for light fixtures and other odd shapes, cutting sheetrock has been more problematic. Sheetrock saws, with coarse teeth do a good job of cutting, but often tear the paper coating on the sheetrock, form a jagged edge, and create a lot of sheetrock dust, which is hard to clean up.

Using a traditional X-ACTO™ knife or the like is difficult, as the knife tends to wander, causing the cut to be uneven. Blades tend to break and dull easily, and if the knife slips while trying to hack through a layer of sheetrock, the user can be badly cut.

Rotary blades have been used for specialized sheetrock cutting saws. These blades, similar to drill bits, have serrated teeth, so when they rotate they cut and powderize the sheetrock. While these can produce a controllable line and make a fine cut, they produce a lot of dust which then has to be cleaned up and presents a breathing hazard. Hole saws and other rotary cutting devices suffer from similar problems.

Thus, it remains a requirement in the art to provide an apparatus which can cut sheetrock accurately, cleanly, and without creating a lot of sheetrock dust.

Reciprocating saws are commonly used in residential and commercial constructions. The most commonly known of these is often referred to as a Sawzall™, which is actually a registered trademark of the Milwaukee Electric Tool Corporation. Such reciprocating saws are generally powered by alternating current (e.g., 110v AC) line power. However, a newer generation of smaller saws are powered by rechargeable batteries. The present invention has also developed an air-powered reciprocating saw, known as the SHINGLEKNIFE™ for use in construction and roofing.

Traditional reciprocating saws typically have a blade that comes to a point at the end. The problem with these types of blades is that if the end of the blade comes out of the cutting slot in a piece of wood or other material, this pointed end then jabs into the material being cut, scarring the surface. Since the saw blade reciprocates and the blade tip has hit a solid surface, the net result is that the reciprocating saw then jerks out of the hand of the user, possibly causing injury, or causing the blade to skate across the surface of the material being cut or adjacent materials, scarring the surfaces. In finishing work, this may mean that many hundreds, if not thousands of dollars of damage occur with just one slip of the saw.

In interior construction, laying wood flooring may require the use of a reciprocating saw when cutting around door jambs or when cutting door jambs themselves. As this is finish carpentry work, any slip of the reciprocating saw may produce scars or mars that affect the finished product.

Thus, what is still required in the art is a saw blade design for a reciprocating saw which is less likely to catch and mar surfaces when cutting materials such as door jambs.

### SUMMARY OF THE INVENTION

In one embodiment of the present invention, SHINGLE KNIFE™, comprises a pneumatically powered miniaturized reciprocating or circular saw designed especially for roofing applications. In an alternative embodiment, SHINGLE KNIFE™ may be powered by rechargeable battery packs or the like. SHINGLE KNIFE™ is roughly size and shape of a Prior Art razor knife, but may be powered and provided with a depth gauge to prevent cutting through roofing underlayment or the like.

In another embodiment of the present invention, the SHINGLE KNIFE™ may be provided for cutting sheetrock. A reciprocating, sharpened hook shaped blade pulls though the sheetrock, making a clean cut with little or no powdery debris. The SHINGLE KNIFE for sheetrock may be air or battery powered.

The present invention also relates to the field of residential and commercial construction. In particular, the present invention relates to an improved reciprocating saw blade design particularly for use in cutting door jams and the like.

In the saw blade design of the present invention, the end of the saw blade is rounded or angled, with teeth provided on the tip of the blade. This allows the blade to cut into the material and not cause the saw to jump back. In contrast, the pointed ends of Prior Art saw blades ten to jam into the material and cause the saw to jump.

### BRIEF DESCRIPTION OF THE DRAWINGS

FIG. 1 is a side view of a pneumatic powered roof shingle cutting tool of the present invention.

FIG. 2 is a perspective view of a pneumatic powered roof shingle cutting tool (SHINGLE KNIFE™) of the present invention.

FIG. 3 is a side view of another embodiment of a KNIFE blade for the reciprocating version of the SHINGLE KNIFE™ Of the present invention.

FIG. 4 is a side view of another embodiment of a KNIFE blade for the reciprocating version of the SHINGLE KNIFE™ Of the present invention.

FIG. 5 is a side view of another embodiment of a KNIFE blade for the reciprocating version of the SHINGLE KNIFE™ Of the present invention.

FIG. 6 is a side view of another embodiment of a saw blade for the reciprocating version of the SHINGLESAW™ of the present invention.

FIG. 7 is a side view of another embodiment of a KNIFE blade for the reciprocating version of the SHINGLE KNIFE™ Of the present invention.

FIG. 8 is a side view of another embodiment of the reciprocating version of the SHINGLE KNIFE™ Of the present invention known as AIR KNIFE™.

FIG. 9 is a side view of the embodiment of the reciprocating version of the SHINGLE KNIFE™ Of the present invention known as AIR KNIFE™ of FIG. 9 illustrating a cutting angle.

FIG. 10 is a side view of another embodiment of the reciprocating version of the SHINGLE KNIFE™ Of the present invention known as AIR KNIFE™ illustrating the angled blade which corrects for the angled cut situation of FIG. 9.

FIG. 11 is a side view of the angled blade of the reciprocating version of the SHINGLE KNIFE™ Of the present invention known as AIR KNIFE™ of FIG. 10.

FIG. 12 illustrates an AIR KNIFE™ blade for mortar joints for use in cutting holes in fiber cement and for cutting mortar.

FIG. 13 illustrates an AIR KNIFE™ hook blade.

FIG. 14 is a cutaway view of a battery powered AIR KNIFE™ of the present invention.

FIG. 15 is an external side view of a battery powered AIR KNIFE™ of the present invention.

FIG. 16 is a side view of a first serrated blade design.

FIG. 17 is a side view of a second serrated blade design.

FIG. 18 is a side view of a third serrated blade design.

FIG. 19 is a side view of a fourth serrated blade design.

### DETAILED DESCRIPTION OF THE INVENTION

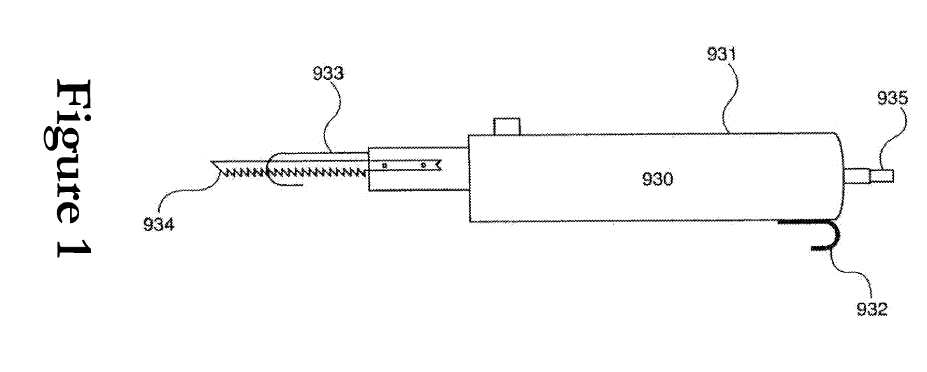

FIG. 1 is a side view of a pneumatic powered roof shingle cutting tool of the present invention. When installing roofing materials, it is often necessary to cut shingles either before installation, or in situ. For example, when building a roof “Valley”, shingles may be installed over the valley, and then later cut to the valley “V” shape. Traditionally, a knife has been used for such cuts. However, there is little precision in depth of cut with a knife, and in addition, such a cut can be laborious and difficult. Too deep a cut may create roof leaks.

Power tools are generally not well suited to cutting shingles. Most are heavy and require electrical power. In addition, large power tools present a hazard to workers below if they fall off the roof. What is needed is a small powered tool which can cut shingles accurately and cleanly. The SHINGLESAW™ 930 of FIG. 1 is, in the preferred embodiment, a pneumatically powered miniaturized reciprocating saw designed especially for roofing applications. In an alternative embodiment, SHINGLESAW™ 930 may be powered by rechargeable battery packs or the like.

SHINGLESAW™ 930 may be provided with a cutting blade 934 of approximately 2″ in length. SHINGLESAW™ 930 may be sized to fit in one hand, much as a prior art razor knife is designed to fit. Adjustable depth gauge 933 may be adjusted to control depth of cut and prevent blade 934 for piercing underlayment or the like. A hook 932 may be provided to allow SHINGLESAW™ to be clipped to a belt or the like. Air chuck 935 allows SHINGLESAW™ to be connected to an air line (such as used for roofing nail guns or the like).

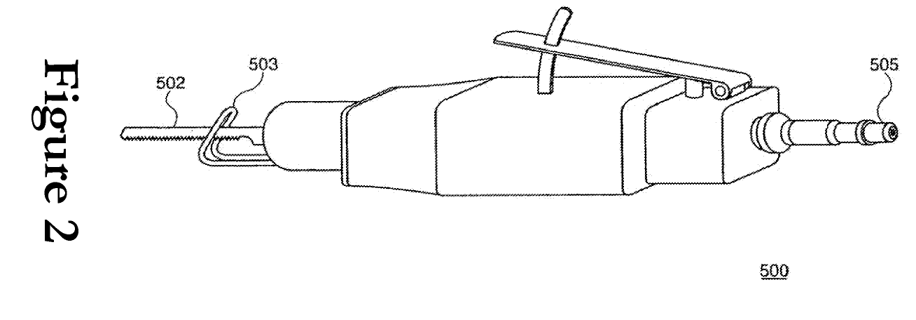

The SHINGLESAW™ 500 of FIG. 2 is, in the preferred embodiment, a pneumatically powered miniaturized reciprocating saw designed especially for roofing applications. In an alternative embodiment, SHINGLESAW™ 500 may be powered by rechargeable battery packs or the like.

SHINGLESAW™ 500 may be provided with a cutting blade 502 of approximately 2″ in length. SHINGLESAW™ 500 may be sized to fit in one hand, much as a prior art razor knife is designed to fit. Adjustable depth gauge 503 may be adjusted to control depth of cut and prevent blade 502 for piercing underlayment or the like. Air chuck 505 allows SHINGLESAW™ to be connected to an air line (such as used for roofing nail guns or the like).

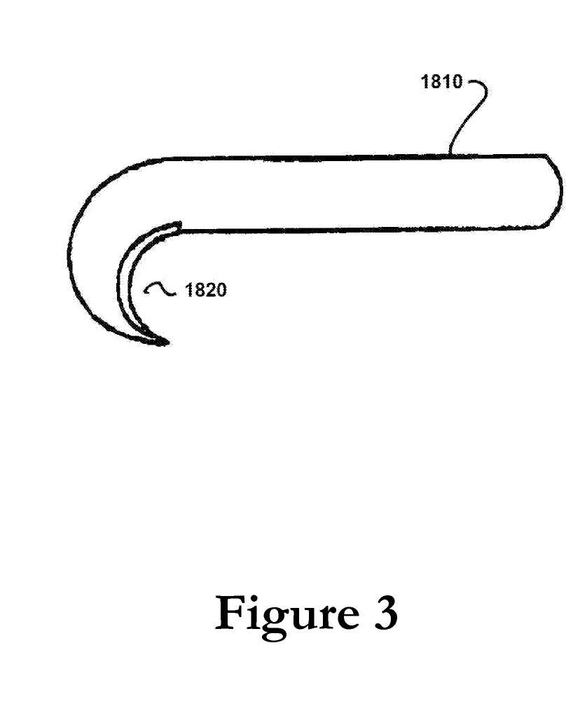

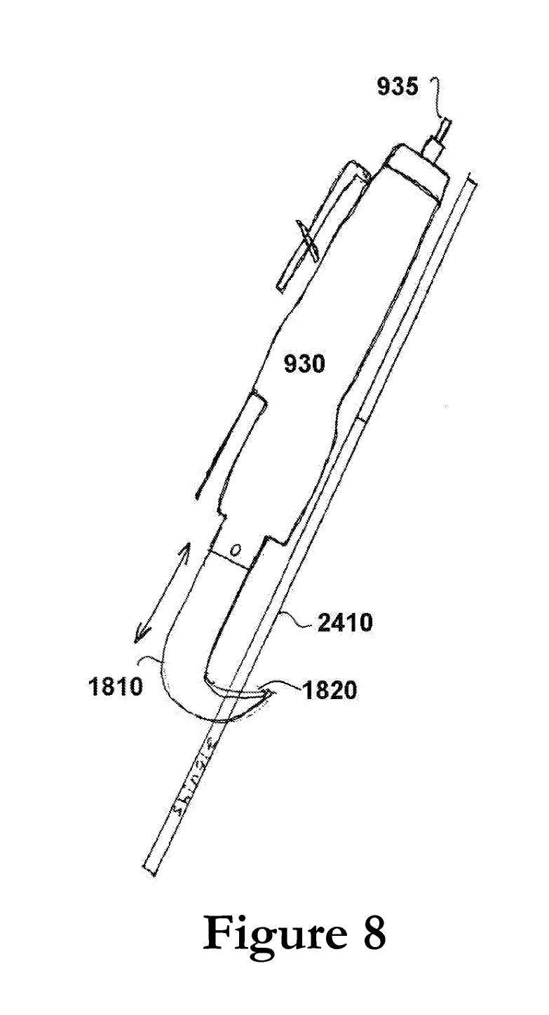

FIG. 3 is a side view of another embodiment of a saw blade for the reciprocating version of the SHINGLESAW™ of the present invention. This blade 1810 may be used, e.g., with the reciprocating air motor of FIGS. 1 and 2, or with an electric reciprocating saw (e.g., SAWZALL™) or the like. The blade may be made from hardened tool steel, mild steel, or stainless steel and may be sharpened 1820 to a fine edge. The use of this blade will be described in more detail in conjunction with FIGS. 8-10.

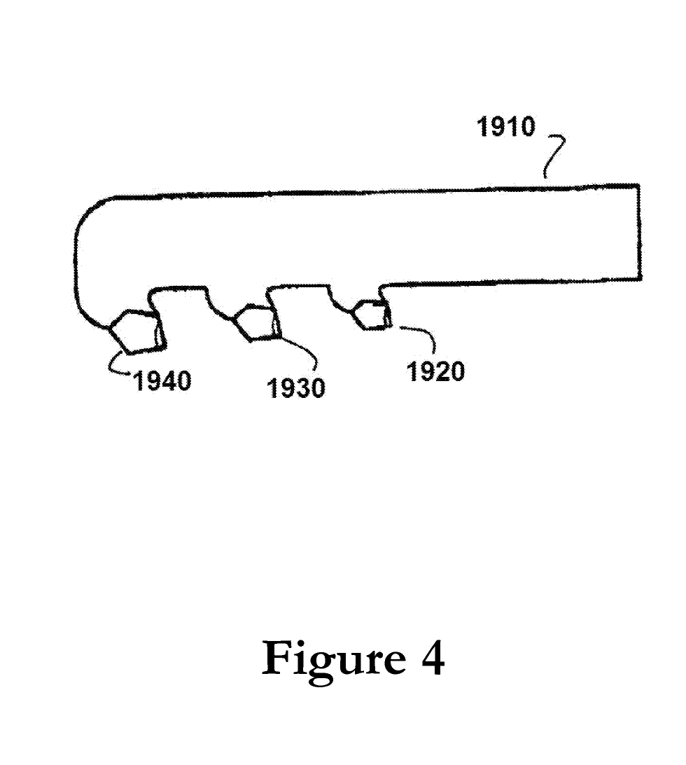

FIG. 4 is a side view of another embodiment of a saw blade for the reciprocating version of the SHINGLESAW™ of the present invention. This blade 1910 may be used, e.g., with the reciprocating air motor of FIGS. 1 and 2, or with an electric reciprocating saw (e.g., SAWZALL™) or the like. The blade may be made from hardened tool steel, mild steel, or stainless steel and may be provided with carbide inserts 1920, 1930, and 1940. The number of carbide inserts may be varied without departing from the spirit and scope of the present invention. Note that each insert 1920, 1930, and 1940 is located at a greater depth than its predecessor. This staggered depth arrangement is designed to avoid digging and binding of the blade. Carbide blade tips 1920, 1930, and 1940 may comprise any of the carbide blade tip designs disclosed herein or known in the art.

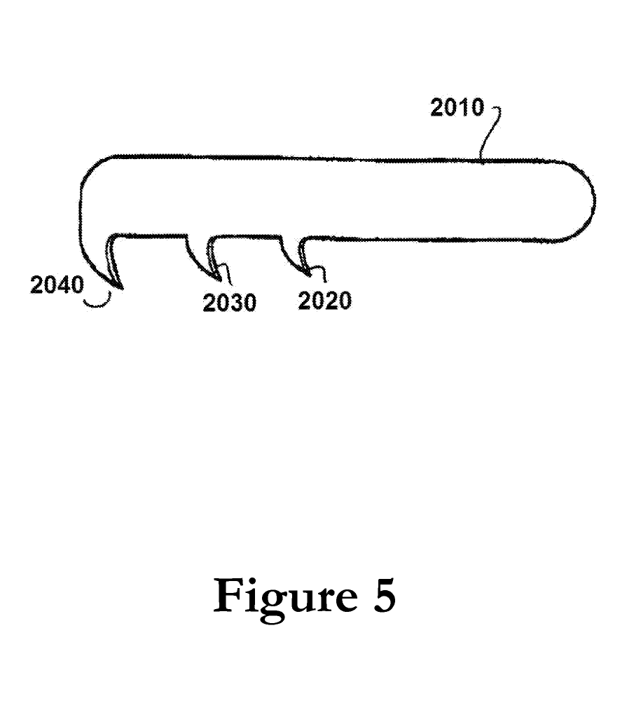

FIG. 5 is a side view of another embodiment of a saw blade for the reciprocating version of the SHINGLESAW™ of the present invention. This blade 2010 may be used, e.g., with the reciprocating air motor of FIGS. 1 and 2, or with an electric reciprocating saw (e.g., SAWZALL™) or the like. The blade may be made from hardened tool steel, mild steel, or stainless steel and may be provided with sharpened blade tips 2020, 2030, and 2040. The number of sharpened blade tips may be varied without departing from the spirit and scope of the present invention. Note that each sharpened blade tip 2020, 2030, and 2040 is located at a greater depth than its predecessor. This staggered depth arrangement is designed to avoid digging and binding of the blade.

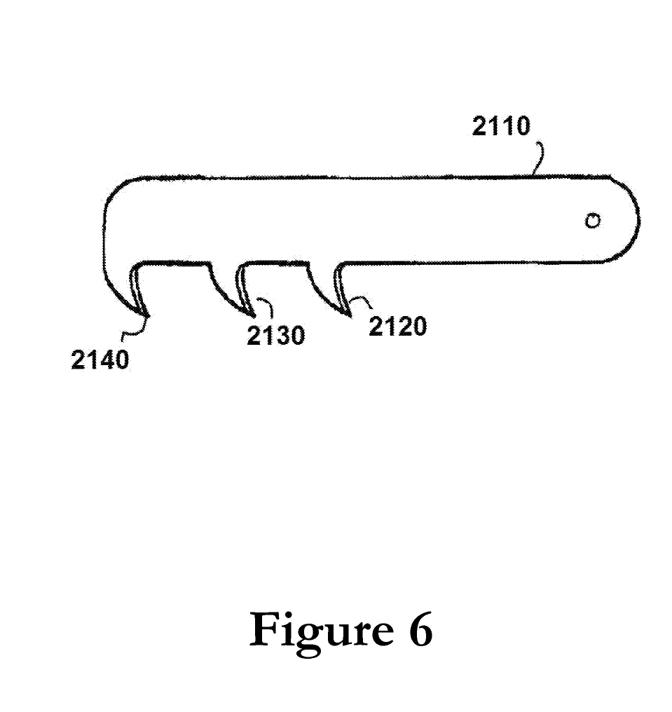

FIG. 6 is a side view of another embodiment of a saw blade for the reciprocating version of the SHINGLESAW™ of the present invention. This blade 2110 may be used, e.g., with the reciprocating air motor of FIGS. 1 and 2, or with an electric reciprocating saw (e.g., SAWZALL™) or the like. The blade may be made from hardened tool steel, mild steel, or stainless steel and may be provided with sharpened blade tips 2120, 2130, and 2140. The number of sharpened blade tips may be varied without departing from the spirit and scope of the present invention. Note that each sharpened blade tip 2120, 2130, and 2140, is at the same depth as its predecessor.

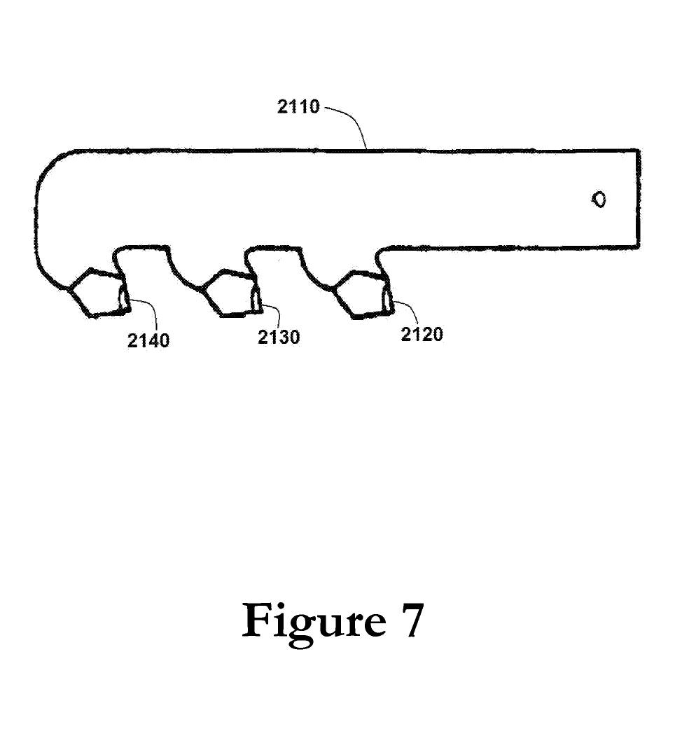

FIG. 7 is a side view of another embodiment of a saw blade for the reciprocating version of the SHINGLESAW™ of the present invention. This blade 2110 may be used, e.g., with the reciprocating air motor of FIGS. 1 and 2, or with an electric reciprocating saw (e.g., SAWZALL™) or the like. The blade may be made from hardened tool steel, mild steel, or stainless steel and may be provided with carbide inserts 2120, 2130, and 2140. The number of carbide inserts may be varied without departing from the spirit and scope of the present invention. Note that each carbide insert 2120, 2130, and 2140 is located at the same depth as its predecessor. Carbide blade tips 2120, 2130, and 2140 may comprise any of the carbide blade tip designs disclosed herein or known in the art.

FIG. 8 is a side view of another embodiment of the reciprocating version of the SHINGLESAW™ of the present invention known as AIR KNIFE™. This Figure illustrates how any of the blade designs of the present invention may be used to cut a shingle 2410 or shingles on a roof. For the sake of illustration, blade 1810 is shown. As illustrated in FIG. 8, the SHINGLESAW™ AIR KNIFE™ 930 may comprise a reciprocating air powered saw as known in the art. Blade 1810 may be attached to AIR KNIFE™ 930 through a chuck, clamp or other device as is known in the art. Note that for purposes of illustration, blade 1810 from FIG. 3 is illustrated here. However any of the blade designs of the present application may be used without departing from the spirit and scope of the present invention.

In use the user holds the AIR KNIFE™ 930 parallel to the roofing surface (e.g., shingle 2410) to be cut as illustrated in FIG. 8. The reciprocating action of blade 1810 cuts through the roofing surface due to the reciprocating action of the AIR KNIFE™ 930 air motor.

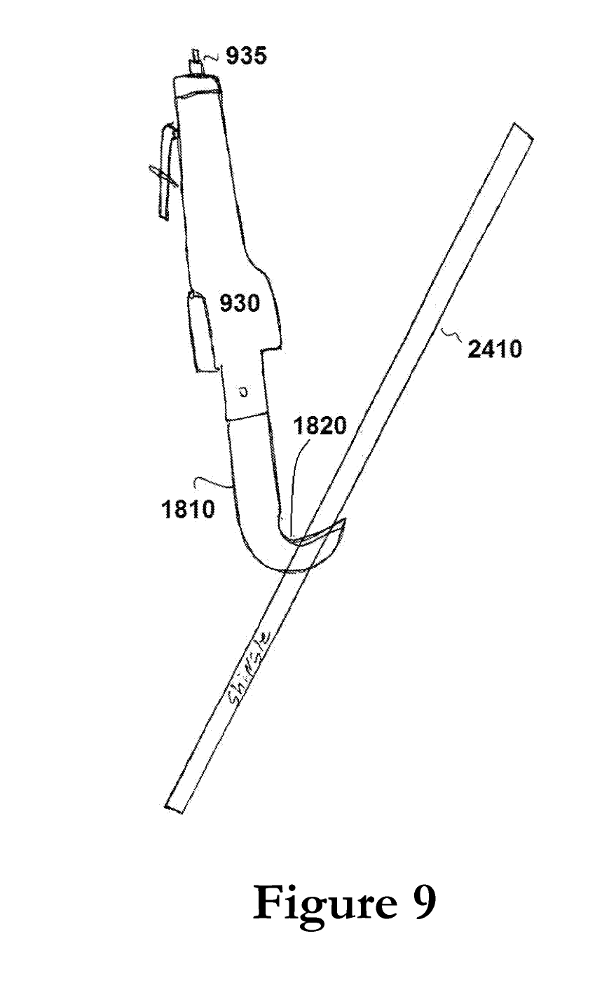

FIG. 9 is a side view of the embodiment of the reciprocating version of the SHINGLESAW™ of the present invention known as AIR KNIFE™ of FIG. 9 illustrating a cutting angle. When in actually use, it may be difficult to hold AIR KNIFE™ at an angle parallel to shingle 2410 as illustrated in FIG. 8. Moreover, such a cutting angle tends to wear on the underside surface of the air motor of AIR KNIFE™ due to the abrasive nature of shingle material. A sole or base plate may be attached to the underside of the AIR KNIFE™ to reduce such wear. The sole may be made from ⅛″ wire stock and may be bent into a loop shape or the like.

Cutting at the angle shown in FIG. 9 places the sharpened blade tip 1820 at a less preferred angle for cutting without binding on the shingle material. And as a result, the blade tip 1820 tends to drag.

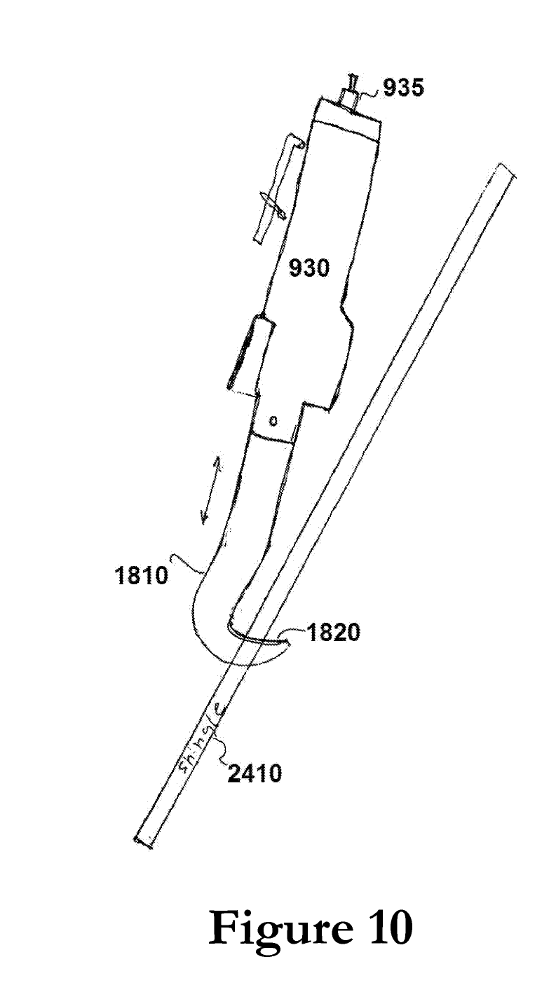

FIG. 10 is a side view of another embodiment of the reciprocating version of the SHINGLESAW™ of the present invention known as AIR KNIFE™ illustrating the angled blade 2510, which corrects for the angled cut situation of FIG. 9. This angled blade 2510, which is the preferred embodiment of the AIR KNIFE™ of the present invention, allows the AIR KNIFE™ 930 to be used at and angle relative to shingle 2410 or other roofing material, while still maintaining an optimal cutting angle with reduced drag.

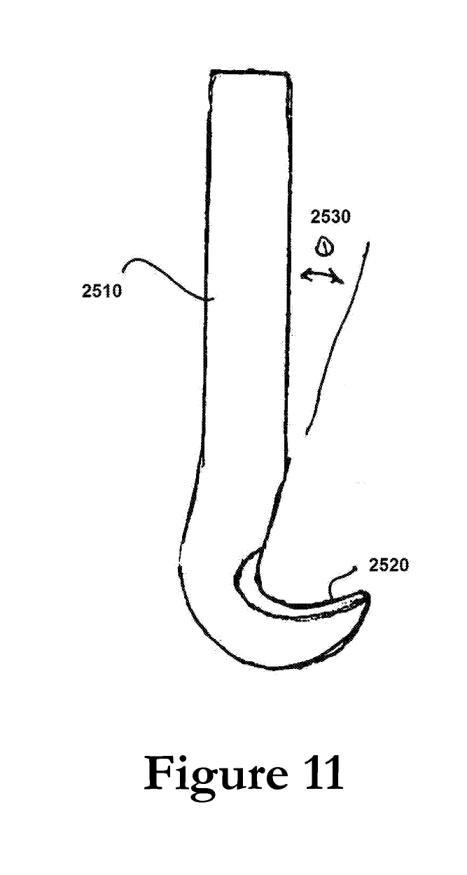

FIG. 11 is a side view of the angled blade of the reciprocating version of the SHINGLESAW™ of the present invention known as AIR KNIFE™ of FIG. 10. It should be noted that this angled embodiment may be applied to any of the blade designs of the present invention without departing from the spirit and scope of the present invention. In the preferred embodiment, the blade angle 2530 may range from approximately 5 to 30 degrees, although other angles may be used within reason.

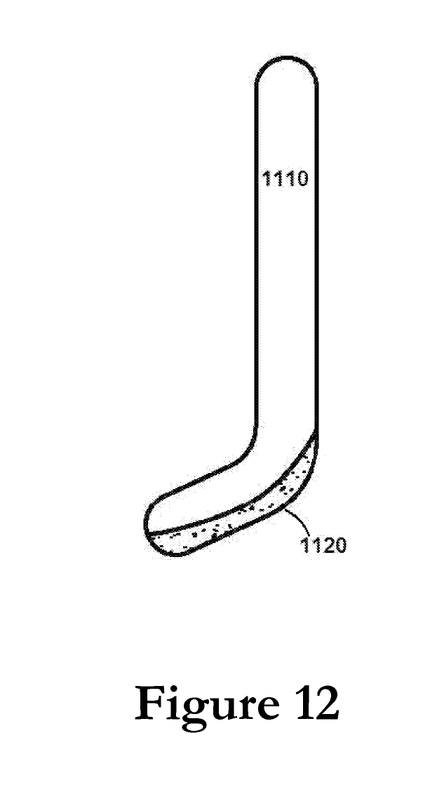

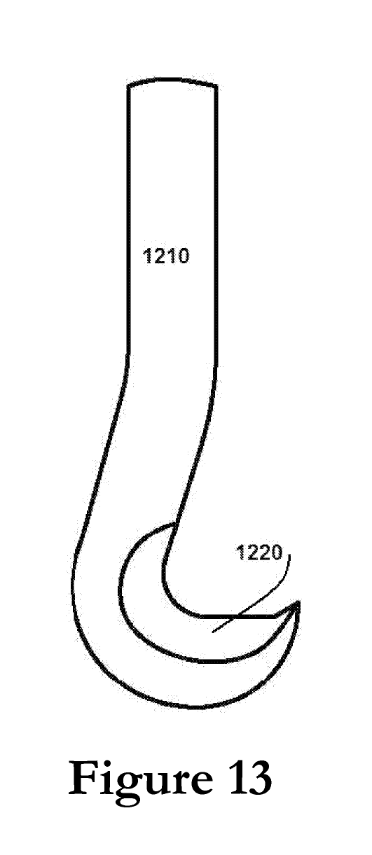

FIG. 12 illustrates an AIR KNIFE™ blade for mortar joints for use in cutting holes in fiber cement and for cutting mortar. This blade 1110 may be impregnated with diamond dust 1120 on the end to provide cutting action. FIG. 13 illustrates an AIR KNIFE™ hook blade 1210 having a more pronounced and sharpened hook portion 1220.

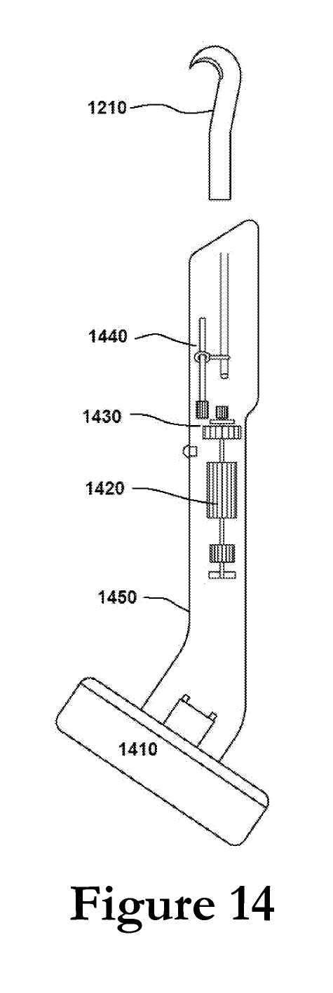

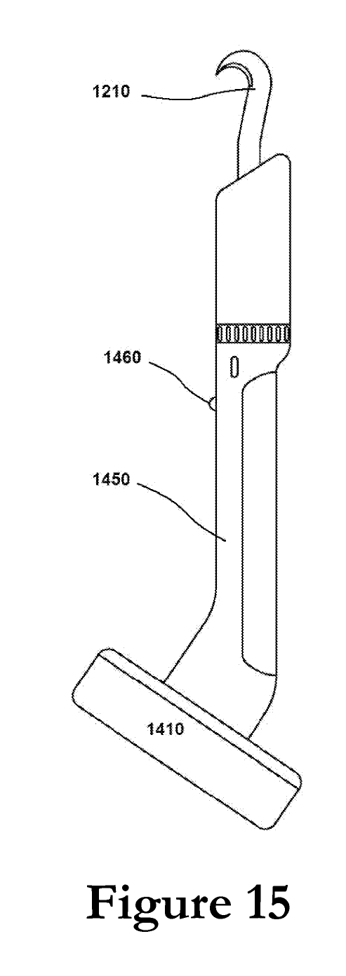

FIG. 14 is a cutaway view of a battery powered AIR KNIFE™ of the present invention. FIG. 15 is an external side view of a battery powered AIR KNIFE™ of the present invention. In this battery powered version of the SHINGLE KNIFE™, a rechargeable battery pack (e.g., 18 volt or the like) 1410 may be provided to power the apparatus. An electric motor 1420 is provide within the unit, including a gear reduction 1430 and oscillation mechanism 1440, to convert rotary motion of the motor 1430 into a reciprocating motion for the knife 1210. Wires from the battery to the motor, via a switch 1460 may be provided to control the action of the blade 1210. Optionally, a variable speed control may be provided to allow for greater cutting control. Any of the knife blades described above may be used with the electric version of the saw. However, in the preferred embodiment, for use with sheetrock, the hook-shaped blade as shown may be used.

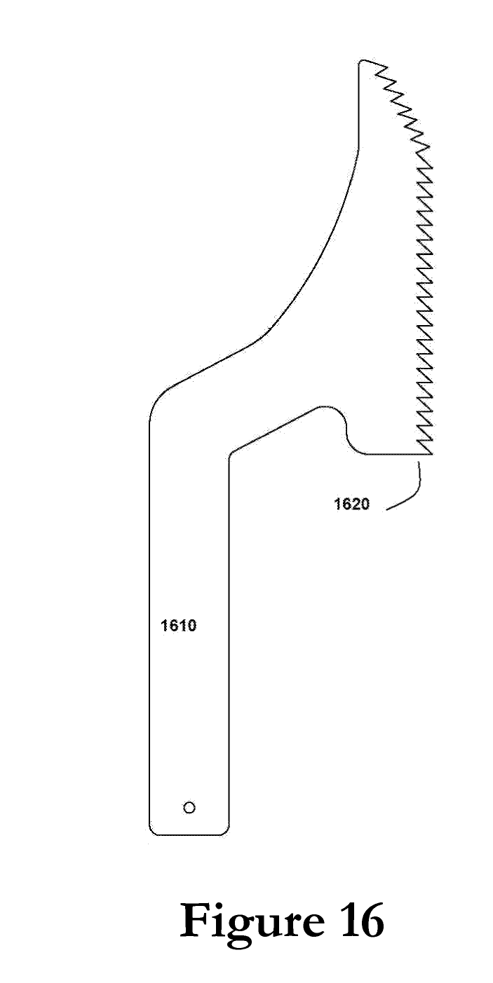

FIG. 16 is a side view of a first serrated blade design, which may be used with the reciprocating saws of the present invention, or with Prior Art reciprocating saws. In the saw blade design of the present invention, the end 1620 of the saw blade 1610 is rounded or angled, with teeth provided on the tip of the blade. This allows the blade to cut into the material and not cause the saw to jump back. In contrast, the pointed ends of Prior Art saw blades ten to jam into the material and cause the saw to jump. Note that the blade is offset from the tang, so the blade can reach down and cut a door jam, without the reciprocating saw body interfering with the cut. Note also the end of he blade is angled up to insure that the blade does not catch on the wood while cutting.

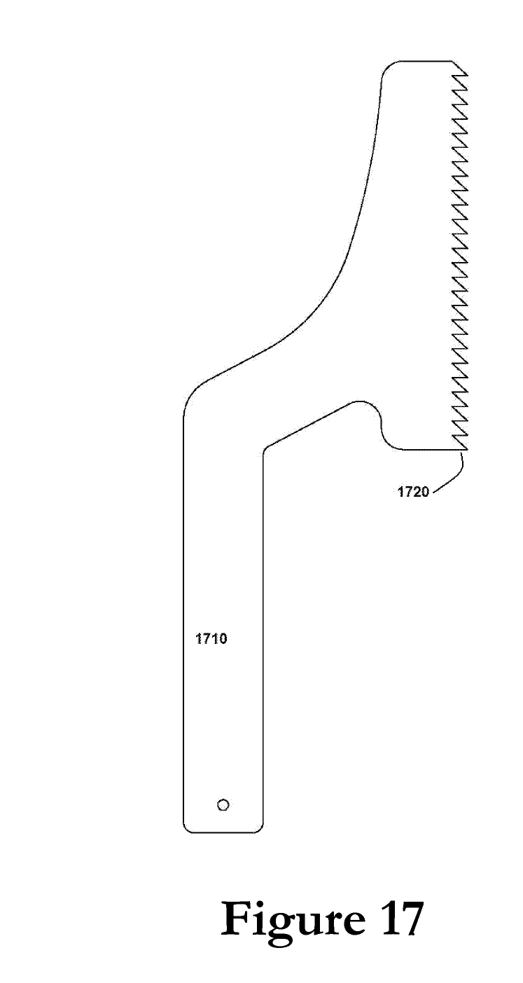

FIG. 17 is a side view of a second serrated blade design, which may be used with the reciprocating saws of the present invention, or with Prior Art reciprocating saws. In the saw blade design of the present invention, the end 1720 of the saw blade 1710 is angled, with teeth provided on the tip of the blade. This allows the blade to cut into the material and not cause the saw to jump back. In contrast, the pointed ends of Prior Art saw blades ten to jam into the material and cause the saw to jump. Note that the blade is offset from the tang, so the blade can reach down and cut a door jam, without the reciprocating saw body interfering with the cut. In this version, the saw blade portion is straight, with no angled tip.

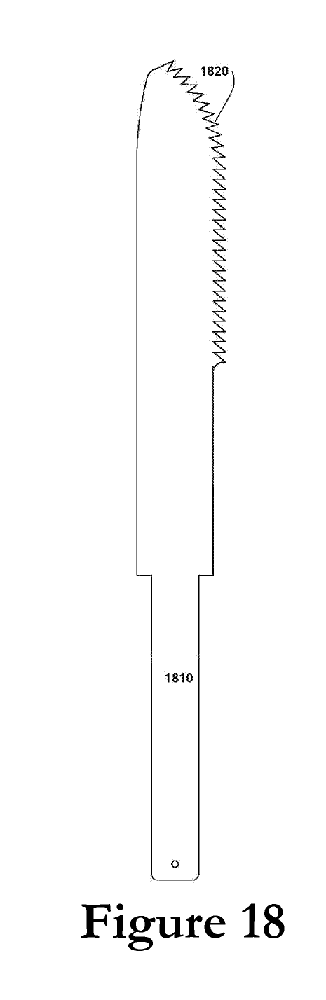

FIG. 18 is a side view of a third serrated blade design, which may be used with the reciprocating saws of the present invention, or with Prior Art reciprocating saws. In the saw blade design of the present invention, the end 1820 of the saw blade 1810 is rounded, with teeth provided on the tip of the blade. This allows the blade to cut into the material and not cause the saw to jump back. In contrast, the pointed ends of Prior Art saw blades ten to jam into the material and cause the saw to jump. This “butter knife” design is shown with a straight tang, but may also be offset. The blade tip is rounded and teeth are provided up to the rounded tip of the saw blade.

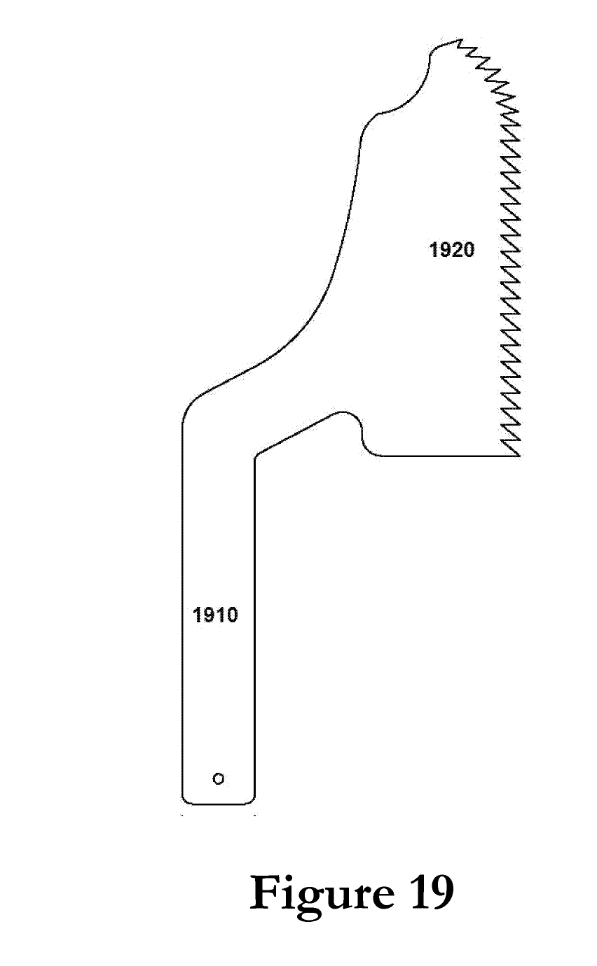

FIG. 19 is a side view of a fourth serrated blade design, which may be used with the reciprocating saws of the present invention, or with Prior Art reciprocating saws. In the saw blade design of the present invention, the end 1920 of the saw blade 1910 is rounded and angled and offset, with teeth provided on the tip of the blade. This allows the blade to cut into the material and not cause the saw to jump back. In contrast, the pointed ends of Prior Art saw blades ten to jam into the material and cause the saw to jump. Note that the blade is offset from the tang, so the blade can reach down and cut a door jam, without the reciprocating saw body interfering with the cut. In this version, the saw blade portion is straight, with no angled tip.

While the preferred embodiment and various alternative embodiments of the invention have been disclosed and described in detail herein, it may be apparent to those skilled in the art that various changes in form and detail may be made therein without departing from the spirit and scope thereof.

It should also be noted that the present inventor has built and tested most, if not all, of the embodiments set forth in the present application, and as a master roofer, has tested all of the apparatus successfully. To the best knowledge of the inventor, no such products are commonly or commercially available to roofers at the time of filing.

1. An electric saw for cutting shingles, comprising:
a rechargeable battery;
an electric motor, coupled to and receiving power from the rechargeable battery;
a transmission for converting rotary motion from the electric motor to reciprocating motion; and
a cutting blade coupled to the transmission, the cutting blade having at least one hook shaped portion for cutting through shingles when reciprocated.

2. The electric saw of claim 1 wherein the cutting blade has a plurality of hook shaped portions of equal length.

3. The electric saw of claim 1 wherein the cutting blade has a plurality of hook shaped portions of different lengths.

4. The electric saw of claim 1, wherein the cutting blade pulls up though the shingles to cut the shingles.

5. The electric saw of claim 1, wherein the at least one hook has a carbide tip.

6. A pneumatic saw for cutting shingles, comprising:
an air inlet for receiving compressed air;
a pneumatic motor, coupled to and receiving compressed air from the air inlet;
a transmission for converting rotary motion from the pneumatic motor to reciprocating motion; and
a cutting blade coupled to the transmission, the cutting blade having at least one hook shaped portion for cutting through shingles when reciprocated.

7. The pneumatic saw of claim 6 wherein the cutting blade has a plurality of hook shaped portions of equal length.

8. The pneumatic saw of claim 6 wherein the cutting blade has a plurality of hook shaped portions of different lengths.

9. The pneumatic saw of claim 6, wherein the cutting blade pulls up though the shingles to cut the shingles.

10. The pneumatic saw of claim 5, wherein the at least one hook has a carbide tip.
